(19) United States
(12) Patent Application Publication
(10) Pub. No.: US 2019/0260705 A1
(43) Pub. Date: Aug. 22, 2019

(54) AN APPARATUS AND METHOD FOR DISCOVERING COMPUTERIZED CONNECTIONS BETWEEN PERSONS AND GENERATING COMPUTERIZED INTRODUCTIONS

(71) Applicant: Emotional Innovations Ltd., Tel Aviv (IL)

(72) Inventors: Yacov GURIEVSKY, Hod Hasharon (IL); Assaf LAUFER, Tel Aviv (IL)

(21) Appl. No.: 16/340,701

(22) PCT Filed: Sep. 19, 2017
(86) PCT No.: PCT/IL2017/051055

§ 371 Date: Apr. 10, 2019

Related U.S. Application Data
(60) Provisional application No. 62/406,065, filed on Oct. 10, 2016.

(51) Int. Cl. H04L 12/58

(52) U.S. Cl. CPC H04L 51/32; G06Q 20/102; H04L 51/04; H04L 51/14

(57) ABSTRACT

The subject matter discloses a computerized method for introducing persons, comprising receiving a request from an introduction generator, generating a list of potential target persons that match the request, each of the potential persons is associated with a mediator, said mediator is a mutual contact of the introduction generator and the person of the potential persons, receiving a selection from the introduction generator, said selection comprises a selected potential person and a selected mediator and creating a mutual conversation at a computerized device used by the selected mediator, said mutual conversation enables the selected mediator to simultaneously converse with the selected potential person and the introduction generator.

### BACKGROUND OF THE INVENTION

The main purpose of social networking web sites is to enable information and reach media sharing based on connections among people who know each other. The social networks allow people to keep in touch, follow up, communicate, chat and share ideas in an instant fashion, from anywhere and anytime. Social media networking platforms can be utilized to contribute to the relationship among people that otherwise would barely meet or talk.

Social networks also enable creation of ad-hoc relationships, which may be based not on the familiarity level of the diverse contacts, but on the specific interest or need. While the social networking applications are very useful to keep the relationship in case of two brothers living in a far distance one from each other, the social networking applications may not always have the characters to establish new connections between two persons who live in close proximity from each other and wish to communicate about a specific matter. Such matter may be sharing a business idea, a mutual interest, sell or buy goods or services, romantic affairs, ad-hoc help/guidance, and the like. Furthermore, in some cases, after establishing a contact between two persons, regarding a special need or requirement, the two persons may wish to terminate the connection and the information sharing.

### SUMMARY OF THE INVENTION

The present invention discloses discovery and introduction of people through a mutual friend, as the friend is defined by a person's telephone contact list, email account contact list or social network contacts. The mutual friend, also defined as a mediator, may be registered or not registered in the computerized system facilitating the discovery and introduction processes. The target persons are either registered or not registered in the computerized system. The present invention also comprises identifying and defining the nature and strength of relationships between people and using the nature of relationships when suggesting the Introduction Generator (IG), the person seeking introduction, multiple options to contact to one or more target persons, according to a request provided by the IG.

The introduction via a mutual contact and understanding which mutual contact is relevant overcomes natural suspicious from the persons that IG wishes to contact, also defined as target persons. The IG input a request for introduction with a specific person into the system, for example a person he/she saw in a social network. The system will process the request and output a list of potential mediators and a familiarity rate of each optional mediator. This way, a targeted introduction is enabled.

In addition, another object of the present invention is that the mediator is not required to registers in the system in order to facilitate the introduction, and the response to the request from the IG may be provided by a link, for example via SMS or instant messaging. The mediator's approval generates a suggestion request link in the target's device, where the target can receive information about the IG and the mediator and respond to the IG's request for introduction.

Another object of the present invention is that the target person is not required to registered in the system in order to be discovered and introduced to, and the suggestion from the mediator may be sent to the target person by a link, for example via SMS or instant messaging, as the system has the target person's contact details.

The present invention discloses a computer-implemented method for discovering computerized connections between persons and facilitating introductions between a person seeking for introductions (also defined as an introduction generator, or IG) and one or more persons that fit the IG's request for introduction. The method comprises utilizing the personal contacts of the parties, as they are represented in their electronic devices, or accounts such as email accounts and social media accounts. Such electronic devices may be defined as, computerized devices, mobile telephones, laptops, personal computers, tablet personal computers, and the like. In some cases, the electronic devices can be electronic spectacles also known as smart glasses, wearable computers, or any other computerized device which can handle computerized method with input and output. In some cases, the method disclosed in the present invention may comprise a computer-based application designed to search for personal connections in other people's contact lists or their networking contact base. Such contact list may be uploaded to a server, or the persons associated with the method allow the server to search in their contact list, either in the electronic device or in the social network profile.

The method disclosed in the present invention may also utilize a system comprising a computer processor which may facilitate the introduction processes among parties sharing certain information or interests. The method may comprise a step of sending a request for introductions with other parties, based on specific engagement requirements. The IG may define one or more mediators that must be contacts of the target persons. The method enables the IG to discover new persons he can get introduced to by the mediators he defined. The mediators are not required to be registered to the system implementing the method and can receive and reply to the IG's request via a link sent in an email message, SMS or instant message. The targets are not required to be registered to the system implementing the method and can receive and reply to the mediator's suggestion via a link sent in an email message, SMS or instant message, and the like The request may be generated by the introduction generator (IG) using the IG's electronic devices. The computerized system may be configured to receive the requests, search for persons that match the request, search for mediators that may connect the IG and a potential person who matches the request and send a list of potential persons, mediators and a familiarity rate defining their digital relationship with the IG.

The method disclosed in the present invention comprises generating a mutual conversation in the mediator's device, to enable the mediator to converse simultaneously with the person selected by the IG and the IG.

The method disclosed in the present invention comprises generating a mutual conversation in one of the parties' (IG and target person) device, to enable them to converse simultaneously with the mediator.

The method disclosed in the present invention comprises generating an introduction request link to be sent to the mediator by the server in response to the IG selecting the mediator. The introduction request link enables the mediator to suggest the introduction to the target person in case the mediator is not registered to the system.

The method disclosed in the present invention comprises generating an introduction suggestion link to be sent to the target person by the server in response to the mediator approving the introduction request from the IG. The introduction suggestion link enables the target person to receive the introduction from the mediator person in case the target person is not registered to the system.

### BRIEF DESCRIPTION OF THE FIGURES

Exemplary non-limited embodiments of the disclosed subject matter will be described, with reference to the following description of the embodiments, in conjunction with the figures. The figures are generally not shown to scale and any sizes are only meant to be exemplary and not necessarily limiting. Corresponding or like elements are designated by the same numerals or letters.

FIG. 1 depicts a mobile computerized device communicating with a computerized system in order to identify personal contacts which may meet the engagement requirements of an introduction generator operating the mobile computerized device, in accordance with exemplary embodiments of the present invention.

FIG. 2 discloses a method for establishing an introduction connection between two persons having at least a single shared personal contact between them, in accordance with exemplary embodiments of the present invention.

FIG. 3 discloses a method of establishing a connection between persons performed by a server that processes the introduction request, in accordance with exemplary embodiments of the present invention.

FIG. 4 shows a graphical user interface allowing the mediator to conduct two conversations simultaneously, with both the target person and the introduction generator, according to exemplary embodiments of the present invention.

FIG. 5 shows a graphical user interface of a target person receiving multiple introduction requests according to exemplary embodiments of the present invention.

FIG. 6 shows a list of optional target persons to engage offered to a person who seeks a personal contact, according to exemplary embodiments of the present invention.

FIG. 7 demonstrates an introduction between two parties by utilizing an instant messaging interface, according to exemplary embodiment of the present invention.

FIG. 8 demonstrates a dual chat managed by the target person, according to exemplary embodiment of the present invention.

FIG. 9 shows a method of defining connection types when the persons are not contact persons of the system's users, according to exemplary embodiments of the invention.

### DETAILED DESCRIPTION OF THE INVENTION

The present invention discloses a method for introducing a person to an introduction generator. The introduction generator (IG) is a person seeking to be introduced to another person, either a specific person or a person according to one or more attributes, such as profession, physical properties such as height, hair/eye color, place of residence, education, hobbies and the like. The process of seeking an introduction may be initiated in a computerized electronic device operated by the IG. The IG may define the requirements and the characters for the person he or she wish to be introduced to, and send the requirements to a server configured to manage all IG's requests and requirements. In some cases, IGs seeking for introductions may also share their personal contact list and details as stored in the IGs' electronic devices, email accounts or computerized applications such as social medial network applications.

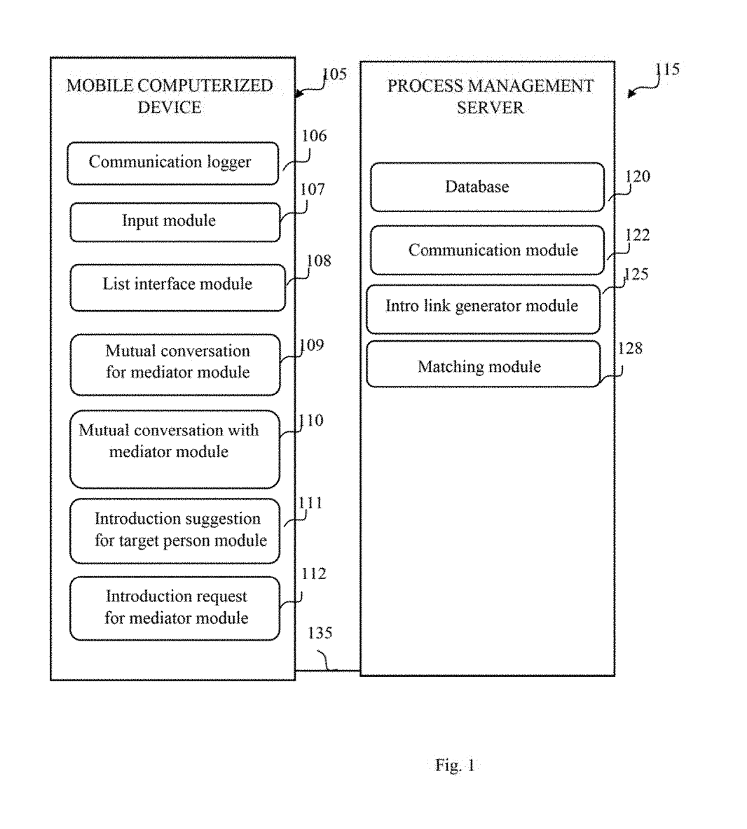

FIG. 1 depicts a mobile computerized device communicating with a computerized system in order to identify personal contacts which may meet the engagement requirements of an introduction generator (IG) operating the mobile computerized device, in accordance with exemplary embodiments of the present invention. FIG. 1 depicts a computerized device 105 which may be operated by an IG and used to identify potential persons for introduction, also defined as target persons. The computerized device 105 may be used to send introduction requests from the IGs to mediators. The computerized device 105 may be PC or tablet, or a mobile computerized device such as a smartphone, smartwatch, virtual/augmented reality glasses and the like. The method may be implemented on a mobile application running on the computerized device 105. The computerized device 105 may be used by the target person to receive introduction requests and suggestions from the mediators, and used by the mediators to receive introduction requests from the IGs and send feedback to the IGs and requests to the target persons.

In some cases, the computerized device 105 may include at least some of the elements associated with the server 115 and vice versa.

The computerized device 105 may comprise a communication logger module 106 designed to monitor the connection events between at least some of the registered persons in the system and their corresponding contacts or persons not included in their direct contact list, while the corresponding contacts don't have to be registered. In some cases, the communication logger module 106 may document the connections events and determine the familiarity rate. For example, the communication logger module 106 may identify that a person contacted another person few times in a raw during a certain period of time. Thus, the communication logger module 106 may update the familiarity rate between them in accordance with several properties such as the connection methods, the frequency, and a rule base defining the conditions for familiarity rates. For example, a person A seeking to contact a person B utilizing text message application and phone calls few times during a single day. The communication logger module 106 may monitor, document the information and in some cases, utilize the information to update the familiarity rate between person A and person B.

The communication logger module 106 may also be designed to monitor activities in a third party applications, such a social media networks, databases of third party internet website, and the like.

In some cases, the communication logger module 106 may also be able to define the type of connections between the persons in accordance with the contact details. For example, the communication logger module 106 may define that a connection between a person A and a person B may be a social connection due to the fact that person A and person B are communicating via a specific social media network application. Person A may be the IG and person B may be the mediator or the target. In some cases, the communication logger module 106 may define that the contact between person A and person B is a business contact due to the electronic mail exchanged between them, the time in the day the electronic mail exchanging take place, and the like. In some cases, the IG can input the contact properties into the computerized module 105 and save the contact type, properties and familiarity rate in a storage of the computerized module 105. The information inputted by the IG, mediator and target, as well as the output from the communication logger module 106 is stored in the server database and used for future requests. Information inputted manually by the IG, mediator and target, as well as selected automatically by the communication logger module 106 is stored in the server database and used for future requests. The information in the databases may be updated frequently or in response to a predefined event, for example update in the users' contact list of social network connection list.

The system may acquire data communication between two persons in multiple communication methods. For example, communication via SMS, email and Facebook engagement may be considered stronger than communication via WhatsApp only. The familiarity rate may consider the number of total messages in a period of time, amount of average words per message, communication method used by the persons and the additional parameters desired by a person skilled in the art.

In some other cases, a connection type may be added manually by a person in order to identify the type of connection a person has with the persons listed in his/her personal contact list. For example, a person may be able to define that a certain person appearing in his/her personal contact list extracted from the smartphone contact list, social media contacts, and the like has a high familiarity rate and the connection type may be defined according to the contact details such as, business, or a family member, a working colleague, and the like.

In some cases, the server 115 also adds connections to the database using statistical analysis, when there is no digital direct connection between the two persons. For example, the server will store audio files, images and video files in which persons interact with each other in real life, and use the files when responding to the IG's introduction request. The information may be captured using smart glasses or microphones. The system will save the date and persons' names of the persons captured by the smart glasses and may use this information when generating the connection paths, since the two persons met in real life, even if there is no digital proof that they know each other.

In some cases, a person registering to the system can request not to be a target when specific persons are mediators. That is, the server will not show this option to the IG. For example, an ex-wife is in a person's contact list, and wishes that romantic introductions will not be suggested when she is the mediator.

The computerized device 105 comprises an input module 107 configured to enable the IG to input information associated with the required introduction. Such information may be a specific name to which the IG wishes to be introduced to. The information may be properties of the person to which the IG wishes to be introduced to, such as physical properties, occupation, place of residence, education institute, profession, business, title, hobbies, marital status and the like. The information may be acquired from a specific mediator who can introduce said target persons. The information may include the mediator details such as the mediator's image, name and the like. The client side of the system enables users to store their personal contact person details, and add personal information such as images, addresses, information about their desired introductions and the like.

In some cases, the IG may input an image, voice or textual message concerning the target or the mediator. For example, the IG can add a mediator's photo or look at the selected mediator using smart glasses and input the image captured by the smart glasses. Similarly, the image can be used by the server as a benchmark, such that the server can find targets having similar properties to the person associated with the image/voice uploaded by the IG.

In some cases the input module may operate automatically by activating a software module such as a widget. For example, when the IG reads an article the input module identifies names in the article and recommends introductions with those persons with the respective paths. The computerized device 105 may listen to the IG's conversations, either vocal or textual, and generate potential target persons the IG may wish to be introduced to.

The input module 107 may also be used by the IG to input his/her personal information, such as text (age, profession, hobbies), images, videos, sound, mean-for-connection and the like, to be found by the server 115 in accordance with others' requests. The mean-for-connection can be such as, phone number, electronic mail address, social media network account details, instant messaging application, and the like.

The computerized device 105 may also comprise a list interface module 108 configured to arrange and present a list of potential persons and mediators sent from the server 115 in response to the request inputted into the input module 107. The persons in the list which may meet at least some of the engagement requirements inputted by the IG. The list interface module 108 uses the database 120 in order to arrange the information to the users. In some cases, the list of persons suggested to the IG may comprise all contacts and personal contacts' details that meet the IG's request. In some other cases, said contact list may comprise additional information associated with the personal contacts detail in the list. The additional information may be other contacts connected to the personal contacts, personal information about the personal contacts, and the like. In some cases, the personal contacts in the list may comprise a familiarity rate which defines how close the target person in the list and the IG are, or how close are the target person in the list and the mediator. The rank may consider social media activity between the two persons, for example outputted by the communication logger 106. In some cases, the IG can filter the results from the server 115 according to the connection type the target has with the mediator, for example rank the results when the most business oriented connection is displayed first.

In some cases, the familiarity rate can be embedded into the contact list representation as a scale of numbers, or icons such as stars, colored points, and the like.

For example, an introduction generator (IG) looks for introductions according to certain areas of interest, and identifies a specific person or persons in one of his/her phone contact list as a mediator. The IG can utilize the familiarity rate to identify the familiarity level between the IG's contact and a target person suggested by the server. The mediator's rate may be influenced by the communication logger 106 and by prior cases in which he agreed to or rejected a request to make an introduction. In some other cases, a connection type may be added to identify the type of connection a person has with the persons listed his/her personal contact list. The communication logger 106 may also be configured to output information related to the connection types.

In some exemplary embodiments of the present invention, the list interface module 108 may display the connection paths between the IG and a target person in the list received from the server 115. The connection path may be defined as a chain of mediators between the IG and the target person. This chain includes at least one mediator, who is in the IG's contact list. The last mediator in the chain is a contact of the suggested target person that meets the request attributes. In case the last mediator is a shared contact of the IG and the target person, the chain will be of length l and the first and last mediator is the same person. The connection path may be defined as a chain of mediators between the IG and the target person. This chain starts with and includes at least one mediator, stored in the IG's contact list. The last mediator in the chain is a contact of the suggested target person. In cases that the mediator is a shared contact of the IG and the target person, the chain will be of length l and the first and last mediator is the same person.

For example, the server 115 identifies a possible target person who meets the engagement requirements. The target person may appear as a contact in multiple contact lists associated with multiple optional mediators appearing in the IG's contact list. The path may include the degrees of connections as the contact separations from that specific person from the list. For example, a contact of a contact, or a contact of a contact of a contact, and the like. For example, an IG may find a target person to engage with as a contact person of a contact person of him/her. Thus, the optional person to engage with may be at the second degree. The IG may select manually the most appropriate path to connect using the input module 107.

In some embodiments of the present invention, the computerized device 105 may utilize computerized processes to automatically determine the required contact path to a certain personal contact and select the path with or without the IG's approval. For example, a seeker can have 3 optional paths to contact a certain person. Each path is via a different personal contact base. The list interface module 108 may utilize automatically computerized processes to identify the optimal path in accordance with predefined parameters. Such parameters may be the maximal degree for connecting. In some cases, the automatically computerized processes may include other parameters such as the minimum rate of familiarity level, the connection type according to the contact details, and the like. For example, a seeker can define that the optional person to engage with may be in high rate of familiarity level (I.E., rate 4 or 5 in a 1 to 5 scale), and a connection type of friendship relationship, rather than business relationship.

In some cases, an introduction will incur a cost, defined by the mediator. The mediator may define different costs for different persons as target persons or as mediators in the connection path. The request of a fee may be defined by a user of the system for a specific IG, specific target person or specific connection type. In some cases, the total introduction cost (including the target cost and the mediators' costs) will be displayed to the IG. The total cost may be updated according to a response from the mediators, for example in case one mediator rejects the request and the system suggests an alternative path. In some cases, the total cost will be updated in response to receiving a fee request from the mediator. In some cases, the total introduction cost is considered when sorting the optional paths suggested to the IG.

The list interface module 108 may utilize automatically computerized processes to identify the most appropriate path according to said parameters. In some cases, the list interface module 108 may be able to recommend one or more paths for the IG or to sort the paths from the most recommended one to the least recommended one, and the like.

In some cases, the database 120 stores connection paths used in the past and use the path when selecting which path to suggest to the IG. In some cases, the information about prior paths may include whether or not specific persons approved requests from another person.

In some cases, the computerized module 105 defines the connection type according to the required introduction type, for example if the introduction type defined by the IG is romantic in nature, the computerized device will search for mediators of a social type, not of a business origin. In some cases the user, as IG or mediator, can input rules into the input module 107. For example, which contact persons can be used for romantic or business introductions. Hence, the IG will input the introduction type when inputting an introduction request and the server will use the type to match the contact persons used as mediators.

In some cases the computerized module can select the connection paths independently, regardless to the server 115. In some cases the first mediator in the path is not required to be registered in the system and can be selected by the IG by inputting the mediator's name or by inputting the mediator's image. In some other cases, the system will recommend a mediator according to predefined parameters and the IG known preferences.

In some cases, the first mediator is not required to be in the IG's contact persons and the system will send him a link with the introduction request and the IG's details.

In some cases, the IG can receive a feedback and see which mediator rejected the request in the path, and the system can automatically suggest an alternative path to the same target via another mediator.

In some exemplary cases, the computerized device 105 comprises a mutual conversation for mediator module 109 configured to enable a mediator to converse simultaneously with the introduction generator (IG) and the target person selected by the IG for introduction. For example, the IG approaches the mediator and asks him for introduction to a target person appearing in the mediator's contact list. The mutual conversation for mediator module 109 will allow the mediator to converse with the IG about the target person, and converse with the target person about the IG by pressing a jump button or area in the display device, without being required to view the mediator's contact list before accessing the other conversation. The mediator can move directly from one conversation to the other. In addition, if the mediator agrees to make the introduction he/she can use an enabling mechanism, for example using an “enable introduction” button to generate an introduction request for the target person using the Introduction suggestion for target person module 1 and mutual conversation with mediator module 110. The mutual conversation can be implemented via a chat based implementation on a 2d screen like smartphone, a mutual video conferences, a hologram based chatting and the like. In case the mediator uses smart glasses, he can perform a gesture captured by a glasses camera and identified as a response to the introduction request. For example, in case the mediator uses smart glasses, he can perform a gesture captured by a glasses camera to press a virtual “enable introduction” button.

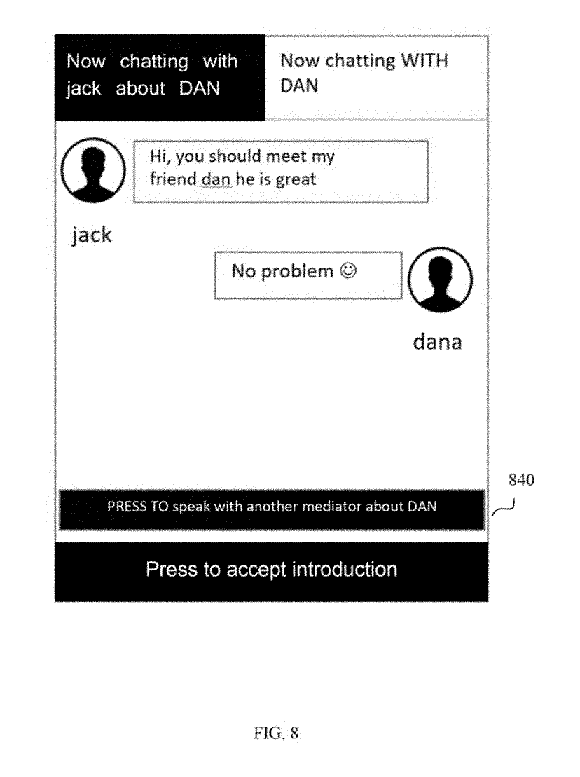

The computerized device 105 comprises a mutual conversation with mediator module 110 configured to enable an IG or the target person to converse simultaneously with the mediator about each other. Module 110 is used by the IG or by the target. For example, the IG approaches the mediator and asks him for introduction with a target person appearing in the mediator's contact list. The mutual conversation with mediator module 110 will allow the IG to converse with the mediator about the target person, and ask for introduction. The mediator module 110 may include an enabling mechanism, such as an “ask for introduction” button. Enabling the introduction by the IG will enable the mediator to use his/her enabling mechanism. For example, the IG can chat about the target with the mediator using the mutual chat, but the IG will want a control over the introduction, such that the mediator will not be able to send an introduction request from the IG to the target without the IG's permission. If both the mediator and the target enables the introduction, the IG will be able to move between the two conversations, to converse with the mediator and to converse with the target person by pressing a jump button or area in the display device, without being required to view the IG'S contact list before accessing the other conversation. In a similar fashion, when the mediator enables the introduction, the mutual conversation with mediator module 110 will allow the target person to converse with the mediator about the IG and with the IG by pressing a jump button or area in the display device. A non-limiting example can be viewed in FIG. 8.

The computerized device 105 comprises an introduction suggestion for target person module 111, configured to present to the target person a list of suggested introduction requests with different IG's, by different mediators, even in case the target person is not registered to the system and if the mediators are not contact persons of the IG and not registered to the system. A new suggestion will be generated when the mediator enables the introduction, for example by pressing an enabling introduction button in module 109. In some cases the target person can select an introduction suggestion and accept the introduction, an event that will open a direct conversation between the IG and the target person. In other cases, the target person will first converse with the mediator about the IG using the mutual conversation with mediator module 110 before approving or not approving the introduction suggestion.

In some cases the target is not registered to the system and can receive a link to the introduction request with information about the IG and the mediator.

The computerized device 105 may also comprise an introduction request for mediator module 112, configured to present to the mediator a list of requested introductions generated by different IG's. A new suggestion will be generated when the IG sends a request to introduce a target person. In some cases, the mediator can select an introduction request from the list, this will open a mutual conversation between the mediator and the IG, as described in module 109.

In possible embodiments of the present invention the mobile computerized device 105 may be connected via connection module 135 to a computerized server 115 designed to send, receive and control the data from computerized devices such as mobile computerized device 105. Connection 135 may be a wired connection such as an internet connection or any telecommunications networks based connection. In some other cases, the connection 135 may end with a wireless connection such as a Wi-Fi, Bluetooth based connection, IR based connection and the like.

The computerize system 115 comprises a database 120 which comprises the data regarding the personal contact, the contact lists, the details, the users of the system, either IGs, mediators and the optional target persons. In some cases, the users utilizing the system may go through a registration process configured to insert the details as well as permitting access to their contact list. Such personal contact lists may be the contact list in the telephone device of the user, contacts acquired form social media network applications, and the like. In some cases, the user may upload digital photos associated with the personal contacts in the list. In some other cases, the data uploaded to the database 120 may also comprises additional information associated with the personal contacts in the personal contact lists. The uploaded data may comprise additional information, additional photos, text titles and messages, files, links, and the like. The system receives contact lists from persons registered to it and finds correlations between contact persons, for example which person is in the contact list of both persons, and can later be used as a mediator. The system can also obtain the date in which the person was added to the contact list.

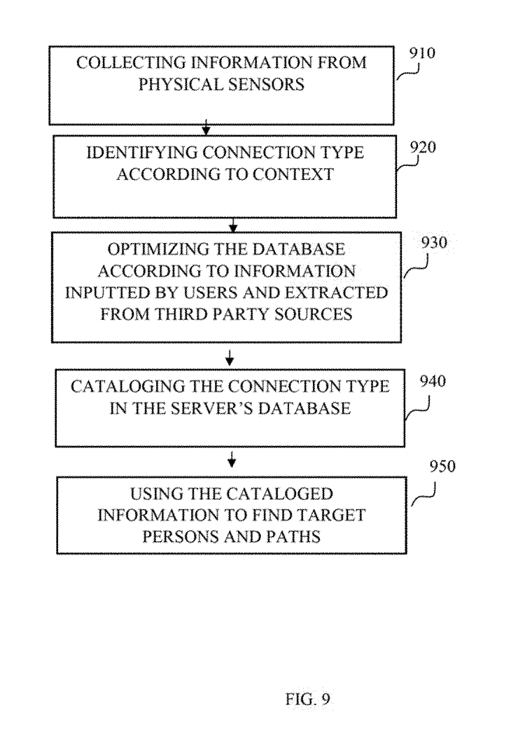

In some cases the system stores the familiarity rate and connection type as determined by the communication logger 106. The connection type may be romantic, business, friendly, based or sensor information as elaborated in FIG. 9, and the like. In some cases the system can enrich the details provided from the persons' devices, for example by adding an image from the social media accounts.

The computerized system 115 may also comprise a communication module 122 designed to manage the communication with the computerized device 105. Such communication may be via electronic email, text messaging application, telephone phone-call, and the like. The communication module 122 may be configured to preserve the communication method performed with the introduction generator (IG) and utilize it when offering optional persons to introduce to the IG.

The computerized system 115 may also comprise intro link generator module 125 designed to generate a link to be sent to the mediator's or the target's device in case they are not registered to the system. The link can be added to or embedded in an email, SMS, instant message and the like. The link may include information about the introduction, and enabling mechanism. For example, such link can be in a form of a URL and then the can open a dedicated website with information about the target and the IG and press a button to approve introduction, an SMS message in which the mediator can reply with 1 to approve or 2 to not approve, a phone call and the like. In some cases the link will disappear after a predetermined time. In case the link is a URL for the mediator, the mediator can press the link and a menu will open in a browser, enabling the mediator to respond to the introduction request. If the mediator declines, a notification is sent to the IG. If the mediator approves, the request is sent to the target person. In case the link is for the target, the target can press the link and a dedicated website will open with the mediator and IG details.

The computerized server 115 also comprises a matching module 128 configured to identify a match to the IG's request. The match is defined as optional target persons that fit to the IG's request according to a predefined set of rules. In some cases, the match is limited to the persons registered to the system. The match may include two or more results, and the connection paths between the IG and each target.

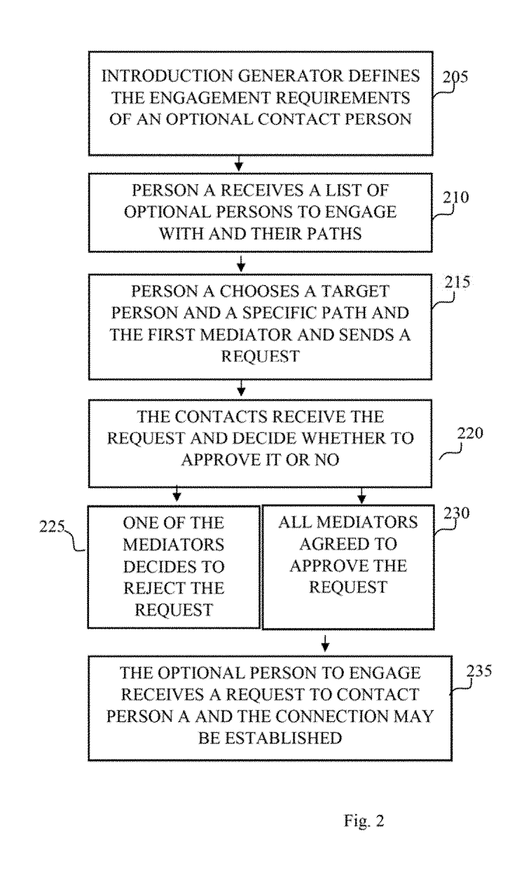

FIG. 2 discloses a method for introducing two persons which have a chain of shared contacts between them while this chain length is minimum one, in accordance with exemplary embodiments of the present invention.

Step 205 discloses receiving a discovery request input from the introduction generator, also defined as person A. In some cases, person A may also has the option to define data filtering on the request results. Such filtering may be by age, by occupation, by business connection only, and the like. This can be done for example by using input module 107.

In step 210 the person A receives a list of the optional persons to engage with in accordance with the definitions set in step 205. In some cases, person A may be able to perform a search on the results received in step 210, in order to define specific contact details, a specific mediator, and the like.

In some cases the IG can filter the request results, for example view only potential target persons with a business connection type.

In some cases, the list of potential target persons comprises a potential person associated with the mediator and the entire connection path to the potential target. The items in the list may be marked and/or sorted according to connection types, number of mediators to each potential target, whether it's a connection via LinkedIn, Facebook or the phone contact list, or all three. The list may show all the mediators, and in each mediator which target persons he leads to, or show the targets and list all the mediators that lead to a specific target.

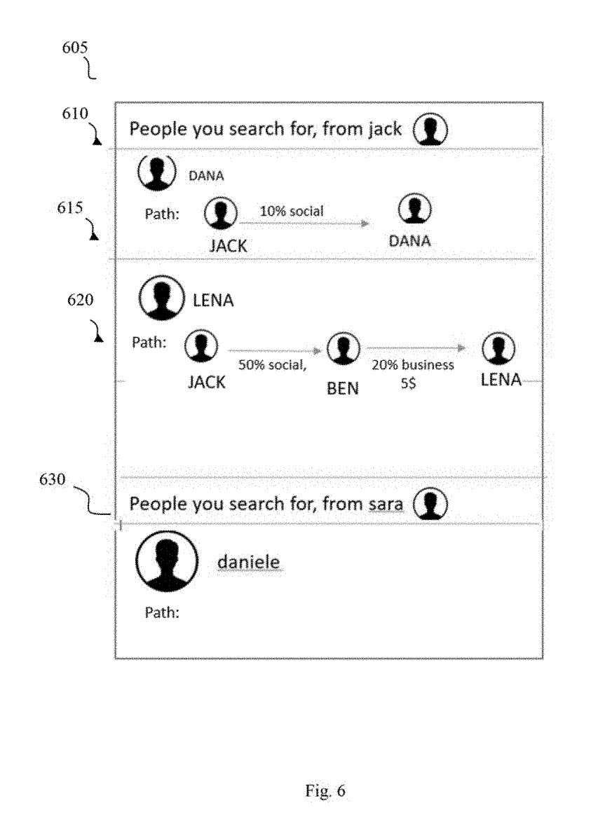

In some case, said list may comprise the path for optional persons to engage with and the degree of connection with them. For example, a list contains 2 persons can show that one of the persons in said list is at the second degree of connection, including the names of the people in each degree, and the second person in said list is at the third degree of connection, including the names of the people in each degree and the type and strength of connection between them, for example friendship connection 9/10. An example can be viewed in FIG. 6. In some cases, the IG may be able to perform a search on the results received in step 210, in order to define specific contact details, a specific connection person, and the like. In some cases, using a path will cost money and the path cost will be displayed to the IG. In some cases, if a mediator in the path decided to charge for advancing the introduction and the price was not set in advance, a message will be sent to this mediator with the path details and the introduction information, and the mediator can send the price back to the IG.

In step 215 the IG chooses the target person to be introduced to, the path for establishing the connection. Then, the selected path and target are sent to the first mediator in the chain, requesting to make the introduction. For example, the selected target person may be connected to person A via two options, each option is via different contacts and in some cases, in different degrees of connections. Person A may choose one of the paths, and the first mediator to send the introduction to in the selected paths.

In some cases the system may recommend a connection path from a plurality of paths leading to the selected target person.

In some cases, the first mediator suggested by the system is not a contact person of the IG. In some cases, if the first mediator in the path didn't perform a registration process, the intro link generator module 125 may provide the link to establish the connection, via a third party application, as described above. In some cases in which the mediator is not registered to the system, the system can send a link, or the IG can send a request in a messaging application, such as email, SMS, instant message and the like. In some other cases, if the first mediator did perform a registration process, the first mediator will receive a new request for introduction via module 112. In some cases, the IG pays the mediator to initiate the introduction process.

In step 220 the first mediator receives the request initiated by the IG. If the first mediator approves the request, other mediators in the connection path receive the request from the previous mediator. In some cases, the request may include the reason for introduction request as inputted by the IG and details of the path itself showing all info about previous and future mediators, the IG and the target person.

In some cases, a mediator in the process didn't perform a registration process, introduction link generation module will generate a link to establish the connection to the mediator, via a third party application, as described above, the link may be sent by the previous mediator using a messaging application, or automatically by the system. In some other cases, if a mediator did perform a registration process, the mediator will get an introduction request as described in module 112, and can use 109 to converse with the IG or the previous mediator about the next mediator in the chain or the target person in case the mediator is the last one. Next, each mediator in the chosen path receives the request and decides whether or not to approve the request. For example, one person in the first degree of connection may receive the request and approve it. Thus, once the request has been approved, the request can continue to the next person in the second degree of connection, until the request is sent to the selected target person. In some cases, all selected persons can receive the request simultaneously, see the response status of other target persons (approve or decline) chat directly between them and with the IG and the like.

In some cases each mediator can add info to the next level, for example—“Please approve this introduction because it is important”.

In some cases, the target will be able to view information about the IG, such as name, age and photos. Additionally, other potential targets contacted to the selected mediator will receive the IG information, for example, according to the potential targets' preferences as stored in the database, as the potential targets are registered to the server.

In some cases, the dual chat between the last mediator and the target may begin without the target approving the request.

In some cases, the target can input rules, for example to automatically approve introduction request from men in the ages of 34-43 from Michigan when the introduction is made via a woman as a mediator.

In some cases, the IG may discuss the fee requested by the mediator. In case the mediator and the IG do not agree on the fee for longer of a predefined amount of time, the system will automatically suggest another path. In some cases, the IG will be able to converse with all the mediators in the path. For example, the IG can ask one of the mediators how well he/she know the next mediator. In some cases, all the parties can chat together, the IG, target and all the mediators, in a group chat.

Step 225 demonstrates the case in which one of the mediators has rejected the request and the engagement process ends. In some cases, the IG who initiated the introduction process or one or all the mediators may receive a message via computerized device 105 or by a link that the process with the specific mediator or mediators stopped, optionally with a message describing why. In some cases, the introduction request can be approved automatically even if not all the mediators approved, for example in case more than 80 percent approved.

Step 230 demonstrates the case in which all mediators in all connection levels approved the request and the target person receives a new suggestion from the last mediator using module 111, the introduction comprises information about the IG, for example information inputted by the IG when initiating the introduction process.

In step 235 the target person receives the introduction suggestion to connect with the IG. This suggestion may include the IG's contact details, including the profiles and all relevant details inputted by the IG for example info and photo, the engagement request requirements, and details about the path including which one of the mediators approved or disapproved the introduction, their details etc.

In some cases, the target person may have the option to ask the mediators questions about the G, before approving the request via Mutual conversation with mediator module 110 via mutual conversation with mediator module 110, as shown in FIG. 8.

In some cases, the mediators may decide to approve direct conversation between the IG and the target person, without the target's approval. This way, a single chat window may be opened between the IG and the target, without the mediator. The target may block the direct chat or decide from which mediators to automatically approve introduction suggestions.

In case the target person is registered to the system, the IG may be able to converse with the target person directly. In case the target person is not registered to the system, the target person may be given the target person's details, and the target may receive a message from the system about it, for example, receive an SMS saying: “someone got your contacts details through an introduction by your friend, Dan”

In case the target person is registered to the system, the IG will be able to converse with the target person directly. In case the target person is not registered to the system, the target person will be given the target person's info, and the target may get a message from the system about it, for example, get an SMS saying: “someone got your contacts details through an introduction by your friend, Dan”.

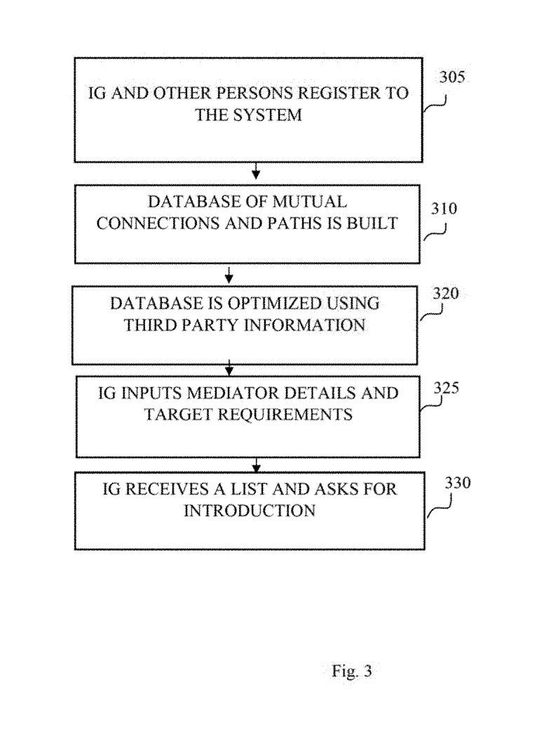

FIG. 3 discloses a method of establishing an introduction between persons performed by a server that processes the introduction request, in accordance with exemplary embodiments of the present invention. Step 305 illustrates how a person registers to the system along with other persons. In some cases the user inputs and/or describes his attributes—for example—single or not, a profession yes or no, height, age, school and features related to its physical structure, his character and so on. In some cases all of the contacts information from the person's computerized device 105 or from third-party sources such as social networks, Email account and others are uploaded to the server 115. In other cases, the nature of his and other contacts are downloaded to the server also by module 106. In some cases all of this information can continue to be downloaded to the server in every time that changes occur, for example, when the person added new contacts to his contact list.

Step 310 discloses generating a Database represents the connection paths between persons. The path database stores the connections between persons, for example via a graph. The paths database is enriched after persons register to the system and their contacts are added to the system and the system identifies new relationships between them.

Step 320 discloses enriching the database with additional information. In some cases, the person A and person B have a shared contact, and person A saved more details on the shared contact, also defined as the mediator. For example, the mediator's image is only stored in one of the person's device. In this case the system will use the image as contact details in case the mediator was not registered to the system. In some cases neither party has such information about the contact picture, or have additional information about this contact, and the system will search third party networks, acquiring such information, e.g. a person registered in his contacts and have a professional he once hired, for example, a patent attorney. Person A does not obtain the patent attorney's image, only his phone number. The system will search third party networks and databases, such as Yellow Pages, LinkedIn, etc. and will associate the phone number to a particular patent attorney. Then, the system will automatically add the person's details found in the third party network to the database. Such information may be photo, name, and reviews and so on. In some cases, the user will be able to add more details to each of his contacts in the system.

Step 325 discloses receiving a target person from the IG. In this case, the IG is looking for a specific contact. The IG can choose parameters which are the same parameters with which it can register section 305. The specific contact person can choose various methods to find the target person, such as inputting the target's image, the target's name and the like, even if the target contact has not signed up to the system.

Step 330 discloses the IG receives a list of target persons, mediators and paths for each target person. In some cases, the same target may be associated with multiple paths.

In some examples, the IG has registered to the system and has a friend that can function as a mediator who did not registered to the system. The IG is looking for a specific professional, meets the mediator at a party. The IG asks the mediator if the mediator knows a professional in a specific field, the mediator replies with a “no”, the IG uploads the mediator's image to the system, which searches the mediator's social network and finds an optional target person in the mediator's contact list,

In another example, both the IG and the mediator registered to the system. One of the mediator's contacts is a patent attorney who did not register in the system. The database optimization and enrichment process will reveal the professional and his details via third-party networks. In case the mediator does not remember the specific patent attorney, the IG will input the mediator's name to the system and the required profession and the system will find the patent attorney.

In another example, the mediator is not required to be in the IG's contact list, and can be found from third party resources.

Dan met his friend and the friend's wife, and asks the friend if he can introduce him to someone. The friend says he does not know anyone but maybe his wife knows a single woman. Dan does not know his friend's wife, and had she is not in his contacts (phone, social networks, etc.). Dan enters the wife's data into the system (text, voice, by sending the photo using Dan's smart glasses). The system recognizes that his wife's friend has three unmarried woman that qualify to Dan's predefined properties. Then, the system indicates that the friend's wife knows one of the three optional targets very well.

In another example, the last mediator in the connection path is not required to be a direct contact of the target person. For example, the IG wishes to be introduced to a specific lecturer he heard of, the IG inputs the lecturer's name into the system which suggests the IG's friend as a mediator. The suggested mediator is not in the lecturer's contact list, but the system stores an event in which the suggested mediator attended the lecturer's lecture, and they may be acquainted.

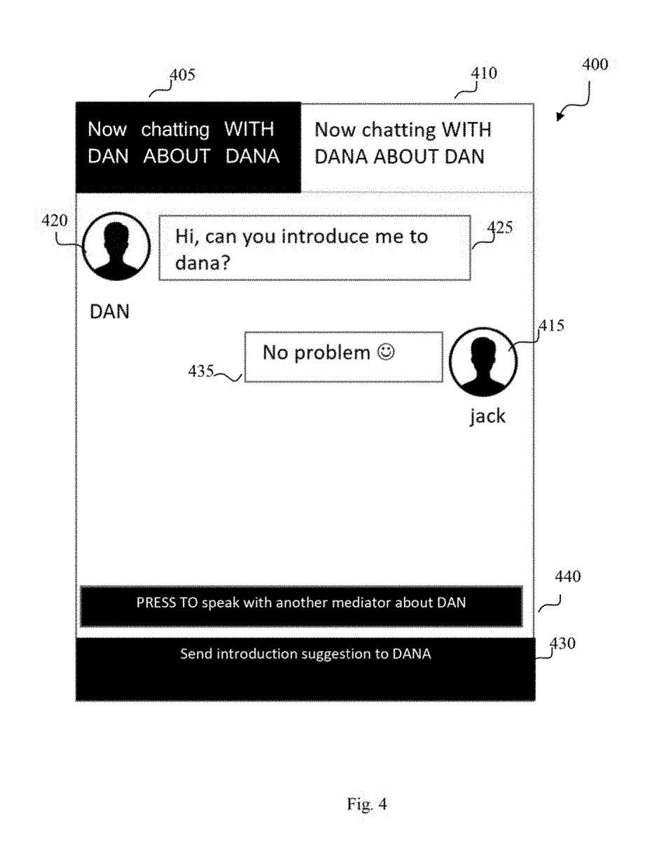

FIG. 4 shows a graphical user interface allowing to manage a chat between a person seeking for introduction to another person and a shared contact identified to facilitate the introduction, according to exemplary embodiments of the present invention. FIG. 4 shows an instant messaging interface 400 enabling the communication between an introduction generator and a mediator. The interface 400 may be implemented via chat, hologram and the like. The instant messaging interface 400 comprises button 410 and button 405 which allow the mediator to manage the discussions between the introduction generator and the target person. For example, in case the mediator wants to chat with the introduction generator, the mediator presses the button 405. In that case, the conversion may be between the mediator and Dan (the introduction generator). In case Jack (the mediator) wants to chat with Danna (the selected person), the mediator, Jack, presses button 410. Such buttons may be chosen by a click on them via computer equipment such as a mouse, or in some cases, by fingers in case of an electronic device equipped with a touch screen. The instant messaging interface 400 also comprises images 420, and 415 configured to contain images of the person participating in the chat. Such images may be a digital photo, an icon, a graphic shape or entity, or additional images which may represent the person participating in the chat session. The instant messaging interface 400 also comprises text boxes 425, and 435 comprising the text shown in each side. In some cases, in which the mediator, chats simultaneously with both parties, each party may be exposed to their own chat's text. In some cases, a chat which takes place with the instant messaging interface 400, may start the conversation between the parties instantly, once the introduction generator chosen to start a conversation with the mediator. Such a chat instant messaging interface may be operated on the electronic device used by the person for communication.

The instant messaging interface 400 may also comprise an approval button 430 which results in a message sent to the target's list of suggestions for introduction.

In some cases, the introduction request opens the chat between the mediator and the target, and the mediator's dual chat interface.

In some cases, when both the mediator and the target are registered to the system, they can both use the dual chat interface.

In some cases, the target person can converse with multiple mediators using tabs. The target can switch mediators while the IG captures the other chat, for example using button 440. The other mediators are not required to be part of the connection path, as long as they are mutual contact persons of both the IG and the target.

In some cases, the target may ask for information about the IG from other mediators who know the IG, before approving the request. In case the target approves the introduction request, the IG can converse directly with the target.

In some cases the mediator can generate the introduction between two persons. This way, both persons, other than the mediator, may have a dual chat opened automatically, or they can receive a link in case they are not registered.

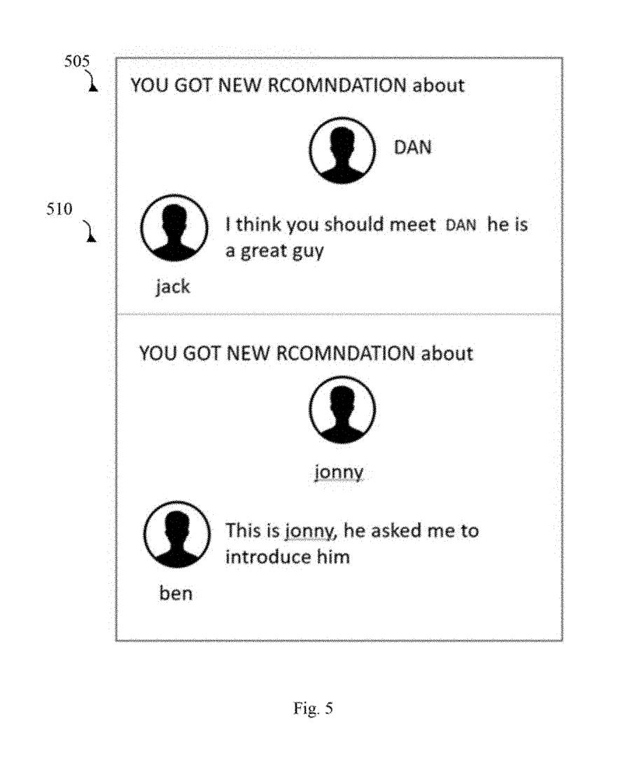

FIG. 5 shows a user interface of a target person, according to exemplary embodiments of the invention. The user interface comprises a list of recommendations for IGs and the mediators who recommended the introduction with each IG. At least some of the recommendations comprise information about the IG 505 and free text 510 from the mediator about the introduction suggested. For example, the first recommendation in the list is Jack introducing Dan, and the second introduction in the list is Ben introducing Jonny. The target may use the target user interface for receiving suggestions, the IG user interface for generating introductions, and the mediator's user interface, all under the same application. The user interface may also include introduction details such as the amount of time each mediator spent before approving the request, money required by each mediator, statistics for each mediator and the like.

FIG. 6 shows a list of optional target persons offered to the IG, according to exemplary embodiments of the present invention. FIG. 6 shows an interface 605 which lists all the suggested optional target persons identified by the list interface module 108 and presented to the IG. The list interface module 108 sorts the optional target persons according to optional mediators, number of connections and the like. The target persons' view can include information like name, photo, additional details etc. The target persons can also view the path to the mediator and to the IG. For example, the optional target persons that may be introduced by Jack are listed in a list beneath the text box 610 which comprises the text: “People you search for, from Jack”. The suggested optional target contacts which can be introduced by Sara are listed beneath the text box 630 which comprises the text: “People you search for, from Sara”. In some cases, additional paths which comprise more degrees of contacts may appear in interface 605, for example the IG can select to be introduced to Dana with the path of 615, or with Lena with the path 620. He can see that jack does not know Dana very well as shown in the low social rate of 10 percent, but he knows a second degree mediator ben, which knows both jack and Lena very well. In that case he might choose the second path. The path may include the cost of each mediator.

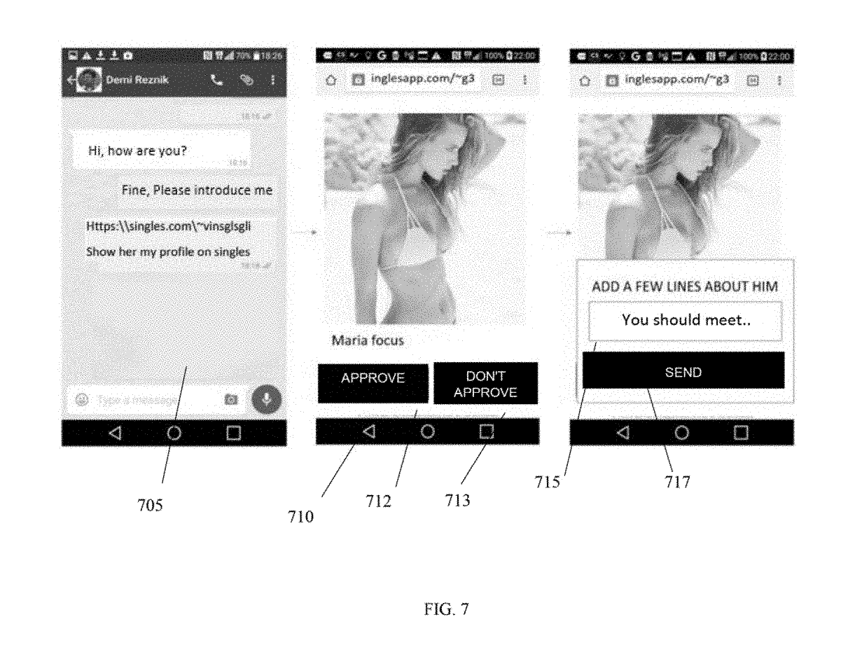

FIG. 7. Demonstrate a method in which the mediator introduces two parties, in the case the mediator is not registered to the system, using link generator 125, according to exemplary embodiment of the present invention. FIG. 7 comprises IG third party instant messaging interface 705 which allows two parties to privately chat. The chat takes place in an IG instant messaging interface 705 may be between an introduction generator and a mediator. Instant messaging interface 705 also comprises a linking text which was originated by introduction link generation module 125, and direct to an information about an introduction request. Such a linking text may be a URL, a link to an account of a social medial network application, a web site, a link to the database 120, and the like. In some cases, the linking text may be a telephone number, an instant message application on a mobile telephone device, an application operated on a personal computer and the like. In some cases, in which a URL is used, the mediator may be able to operate the URL from the instant messaging interface 705, and opens a dedicated website, shown in mediator message section 710. Mediator message section 710 shows the target of the URL as the mediator receives it.

In some cases, in case the mediator does not approve the introduction, the mediator can press button 713 to generate a message in the IG's computerized device 105 that the introduction is not approved. In some cases, the mediator will be given a text box to explain why he did not approve the request, as shown in text box 715.

In some cases, the instant messaging IG interface 705 comprises a button 712 which can be used to approve the introduction, or in some cases, to show information to one of the parties. IG instant message interface 705 may allow adding information about the introduction generator, so only the person who is asked to be introduced can be exposed to that information. For example, message 715 shows additional text input for the mediator to write additional info to the recipients. If the mediator approved the introduction, he might use 715 to add info about the IG, for example: “you should meet him”, this additional information will be viewed by Maria in her module 111 alongside the introduction suggestion. If the mediator didn't approve the introduction, he might use the text box 715 to write to the IG “sorry, I don't think she is for you”

FIG. 8. Shows a dual chat interface between the target person and the mediator. The dual chat is from the target's point of view. The target's dual chat interface is generated when the mediator approves the introduction, which opens a chat between the mediator and the target, in which the mediator introduces the IG to the target. In some cases, the target has to approve the introduction in order for the IG to chat with the target.

In some cases, the target will be given the option to speak with the mediator about the IG, in case the path includes more than one mediator. In some cases, there will be other paths to the IG, originating from the target, and the target may be able to imitate dual chats with other mediators about the IG, mediators which weren't in the path, selected by the IG. In some cases, the target may be able to chat in a group of mediators about the IG—in this example DAN, so the left side of the screen will be a chat with a group rather than only one mediator—in this example JACK. In some cases, the target person can converse with multiple mediators using tabs.

FIG. 9 shows a method of defining connection types when the persons are not contact persons of the system's users, according to exemplary embodiments of the invention. Step 910 discloses collecting information from physical sensors, for example from cameras, smart glasses cameras, microphones and the like. The information comprises images, names, locations, timestamps and the like. Step 920 discloses identifying connection type according to context. For example, using images and names captured from audio files or name tags in images to find these persons, for example by correlating the location of the person to the name appearing in the name tag. Then, the system can calculate a probability that the person associated with the smart glasses knows the person appearing in the image captured by the smart glasses, even if both persons are not contact persons in a social network or in the telephone contact list

Step 930 discloses enriching the database according to information inputted by users and extracted from third party sources. The system can then display the data from the third parties to the IG and ask to input additional information or verify the collected information. Step 940 discloses cataloguing the connection type in the server's database. Step 950 discloses using the cataloged information to find target persons and paths.

While the disclosure has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings without departing from the essential scope thereof. Therefore, it is intended that the disclosed subject matter not be limited to the particular embodiment disclosed as the best mode contemplated for carrying out this invention, but only by the claims that follow.

1. A computerized method for introducing persons, comprising:
receiving a request from an introduction generator;
generating a list of potential target persons that match the request, each of the potential persons is associated with a mediator, said mediator is a mutual contact of the introduction generator and the person of the potential persons;
receiving a selection from the introduction generator, said selection comprises a selected potential person and a selected mediator,
creating a mutual conversation at a computerized device used by the selected mediator, said mutual conversation enables the selected mediator to simultaneously converse with the selected potential person and the introduction generator.

2. The method of claim 1, wherein the request comprises the selected potential person.

3. The method of claim 1, wherein the request comprises one or more attributes, wherein the method comprises receiving the one or more attributes at a server and processing the request by the server.

4. The method of claim 1, further comprises receiving preferences from the introduction generator and ranking the potential persons in the list of potential persons according to the preferences.

5. (canceled)

6. The method of claim 1, wherein the mutual conversation is a vocal conversation.

7. The method of claim 1, further comprises the server storing a contact list of the mediator, and wherein the introduction generator and the selected potential person are both contacts in the contact list of the mediator's mobile phone.

8. The method of claim 1, wherein the introduction generator and the selected potential person are both contacts of the mediator in a social network.

9. The method of claim 1, wherein the social network offers instant messaging conversations, and wherein the mutual conversation is an instant messaging conversation managed via the social network.

10. The method of claim 1, further comprises receiving information from the IG about a specific introduction and sending the information to the selected person in case the mediator agrees to introduce the IG and the selected person.

11. The method of claim 1, wherein the list of potential target persons comprises paths, each path represents connections that lead from the introduction generator to the target person.

12. The method of claim 1, wherein the paths include more than one mediator.

13. (canceled)

14. The method of claim 11, wherein the server automatically selects a path from multiple optional paths leading to the selected target person.

15. The method of claim 11, wherein the introduction generator selects the path from multiple optional paths leading to the selected target person.

16. (canceled)

17. (canceled)

18. The method of claim 11, wherein the introduction request is sent via a link in case the receiver of the introduction request is not registered at the server.

19. (canceled)

20. (canceled)

21. (canceled)

22. (canceled)

23. (canceled)

24. The method of claim 11, further comprises receiving a selected mediator's name in case the selected mediator is not registered at the server, and identifying the selected mediator in the server, and identifying optional target persons having the selected mediator as mediator, wherein the mediator is identified in a contact list of the optional target persons, said contact list is stored in the server.

25. The method of claim 11, further comprises computing a probability that a mediator not contacted to the target person knows the target person, based on information collected by physical sensors and uploaded to the server.

26. The method of claim 11, further comprises identifying changes in the users' contact lists and uploading the contacts to the server.

27. (canceled)

28. (canceled)

29. The method of claim 1, wherein the definitions comprises the user requesting payment in order to approve the introduction request

30. The method of claim 11, further comprises receiving an image from the introduction generator at the server and finding optional target persons according to similarity to the received image.

31. (canceled)

32. (canceled)

33. The method of claim 1, wherein the server suggests an introduction in response to capturing a conversation between a user and another person.

34. (canceled)
